(19) United States
(12) Patent Application Publication
(10) Pub. No.: US 2026/0244410 A1
(43) Pub. Date: Aug. 20, 2026

(54) SYSTEMS AND METHODS FOR GENERATING SOURCE CODE

(71) Applicant: Strivacity, Inc., Herndon, VA (US)

(72) Inventors: Keith Martin Graham, Ashburn, VA (US); Stephen Garnett Cox, Leesburg, VA (US)

(21) Appl. No.: 19/543,377

(22) Filed: Feb. 18, 2026

Related U.S. Application Data
(60) Provisional application No. 63/759,897, filed on Feb. 18, 2025.

(51) Int. Cl. G06F 8/33

(52) U.S. Cl. CPC G06F 8/33

(57) ABSTRACT

A method for generating source code for workflows used in an Identity and Access Management (IAM) system. The method includes receiving a request relating to a workflow in association with an IAM system and retrieving data that is contextually relevant to the request from at least one database. A generative artificial intelligence (AI) model analyzes the retrieved data to determine orchestration logic, policy considerations, and an implementation framework for the workflow. The generative AI model generates a response to the request that includes source code for deploying the workflow in the IAM system, the source code being generated to comply with the orchestration logic, policy considerations, and implementation framework.

### CROSS-REFERENCE TO RELATED APPLICATIONS

This application claims priority to U.S. Provisional Application No. 63/759,897, filed on Feb. 18, 2025 and titled “SYSTEMS AND METHOD FOR GENERATING SOURCE CODE,” the entire disclosure of which is hereby incorporated by reference.

### TECHNICAL FIELD

The present disclosure relates to systems and methods for generating source code, and in particular to methods, devices, and systems for generating source code for identity workflows used in Identity and Access Management (IAM) systems using generative artificial intelligence.

### BACKGROUND

Generating source code for identity workflows used in Identity and Access Management (IAM) systems has traditionally been a manual and time-consuming task that requires expert knowledge. IAM systems require custom code to design complex workflows for user provisioning, deprovisioning, access approval processes, and integration with third-party systems. Organizations must frequently customize identity workflows to address specific business requirements, such as implementing multi-factor authentication (MFA), conditional access policies, or just-in-time (JIT) provisioning. Current approaches often require deep technical expertise to manually code and configure these workflows. This process can be time-intensive, resource-heavy, and inaccessible for teams without strong development capabilities, leading to inefficiencies and delayed implementations.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

In various examples, the subject matter described herein relates to systems and methods for generating source code for workflows used in an Identity and Access Management (IAM) system. At least one aspect of the present disclosure is directed to a method includes receiving a request relating to a workflow in association with an IAM system and retrieving data that is contextually relevant to the request from at least one database. A generative artificial intelligence (AI) model analyzes the retrieved data to determine orchestration logic, policy considerations, and an implementation framework for the workflow. The generative AI model generates a response to the request that includes source code for deploying the workflow in the IAM system, the source code being generated to comply with the orchestration logic, policy considerations, and implementation framework.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a block diagram of a workflow generation system, in accordance with some embodiments.

FIG. 2 is a flowchart of a method for generating workflow source code, in accordance with some embodiments.

FIG. 3 is a diagram of an example dashboard for generating workflow source code, in accordance with some embodiments.

FIGS. 4A-4C are diagrams of additional examples of source code workflows generated by the system, in accordance with some embodiments.

FIG. 5 is a block diagram of an example computing device.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Disclosed herein are exemplary embodiments of systems and methods for generating source code. In particular, described are various embodiments which use generative artificial intelligence (AI) to generate source code for identity workflows used in Identity and Access Management (IAM) systems.

IAM systems are designed to manage digital identities and control access to resources within an organization. IAM systems ensure that the appropriate individuals or systems have the correct access permissions to data, applications, and other resources, based on predefined roles and policies. IAM systems encompass various components, including identity management mechanisms which centralize the creation, modification, and deletion of user accounts. Authentication mechanisms within IAM systems verify the identity of users or systems attempting to access resources using methods like passwords, biometrics, multi-factor authentication (MFA), or single sign-on (SSO). Authorization mechanisms determine the specific resources users or systems can access and the actions they are allowed to perform, relying on models such as Role-Based Access Control (RBAC) or Attribute-Based Access Control (ABAC). Access management mechanisms enforce these control policies in real time, managing sessions and revoking access as necessary.

In many cases, IAM systems use workflows to structure processes designed to manage the lifecycle of user identities and their access to organizational resources. Such workflows ensure secure and efficient access to systems, data, and applications while adhering to organizational policies and compliance requirements. For example, user provisioning workflows may automate the creation of user accounts and assignment of roles or permissions based on job functions or organizational hierarchies. Likewise, access request and approval workflows may allow users to request specific resources, with managers or administrators reviewing and granting or denying access in accordance with predefined policies. Authentication workflows may verify user identities using methods such as passwords, MFA, or SSO, while authorization workflows enforce access control models (e.g., RBAC or ABAC) to determine what resources users can access.

Often times, such IAM workflows require custom code to be written. For example, custom code may be needed to design complex workflows for user provisioning, deprovisioning, or access approval processes. Integration with third-party systems often requires leveraging APIs or SDKs to connect the IAM system with external applications, databases, or services, such as HR systems or custom tools. Additionally, event-driven automation may involve writing scripts or programs to trigger specific actions, such as account lockouts, role changes, or security incident responses. Complex policy implementations, such as attribute-based access controls (ABAC), may also demand custom scripting to define granular access rules. Furthermore, organizations may need to develop custom authentication mechanisms, such as integrating new biometric systems, or perform data transformation and mapping to synchronize identities across disparate systems. In some cases, custom scripts or queries are required to generate audit logs, reports, or analytics tailored to organizational requirements. Such workflows may be referred to collectively as “identity workflows.”

As such, organizations must frequently customize identity workflows to address specific business requirements, such as implementing MFA, conditional access policies, or just-in-time (JIT) provisioning. Current approaches often require deep technical expertise to manually code and configure these workflows. This process can be time-intensive, resource-heavy, and inaccessible for teams without strong development capabilities, leading to inefficiencies and delayed implementations. Accordingly, systems and methods are provided herein that leverage generative AI to streamline the creation and customization of identity workflows through natural language processing, reducing the need for manual coding and enabling rapid deployment of identity workflows.

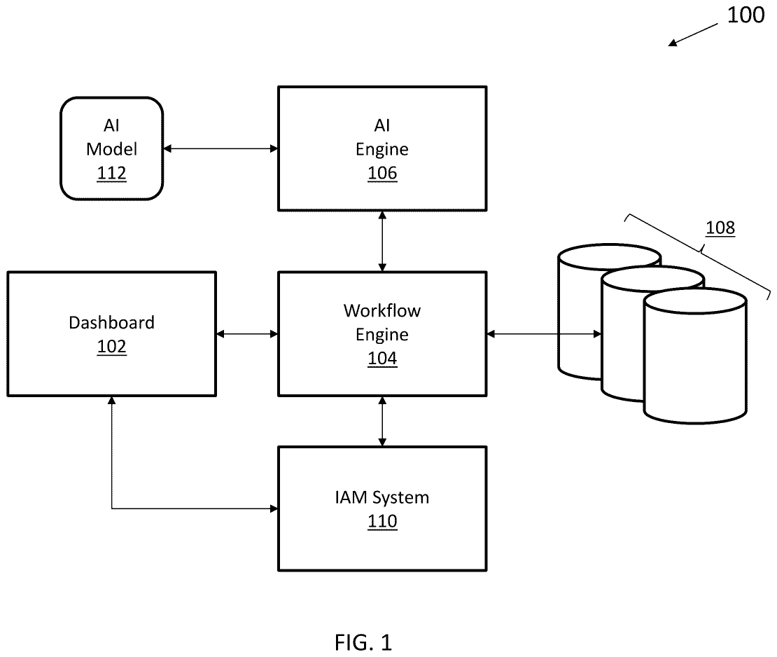

FIG. 1 is a block diagram of a workflow generation system 100 in accordance with embodiments described herein. The system 100 includes a dashboard 102, a workflow engine 104, an AI engine 106, and a plurality of databases 108. In some examples, the dashboard 102 is a user interface (UI) that enables the user (or operator) to interact with a IAM system 110. In some examples, the IAM system 100 is a Customer Identity and Access Management (CIAM) system. In some examples, the dashboard 102 is a web interface accessed via a web browser. In some examples, the dashboard 102 corresponds to the UI of a standalone application or program configured to run locally on a user device or in the cloud. In some examples, the workflow engine 104 is a software component that is configured to run on one or more servers (e.g., an application server). In some examples, the workflow engine 104 is included in a standalone application with the dashboard 102.

The AI engine 106 includes, or is configured to interact with, at least one AI model 112. In some examples, the AI model 112 is a generative AI model. In some examples, the AI model 112 is a large language model (LLM). In some examples, the AI model 112 is an internal model that runs on an application server (e.g., with the workflow engine 104) or in a standalone application. In some examples, the AI model 112 is an external model that the AI engine 106 communicates with via one or more APIs. In some examples, the AI model 112 is a foundational model. In some examples, the AI model 112 is a specialized model that is trained solely for use with the system 100. The plurality of databases 108 are configured to store data used by the workflow engine 104. In some examples, the databases 108 store datasets of code, documentation, programming discussions and instructions, and IAM settings and preferences. In some examples, at least a portion of the data stored in the plurality of databases 108 is vectorized or otherwise optimized for Retrieval-Augmented Generation (RAG).

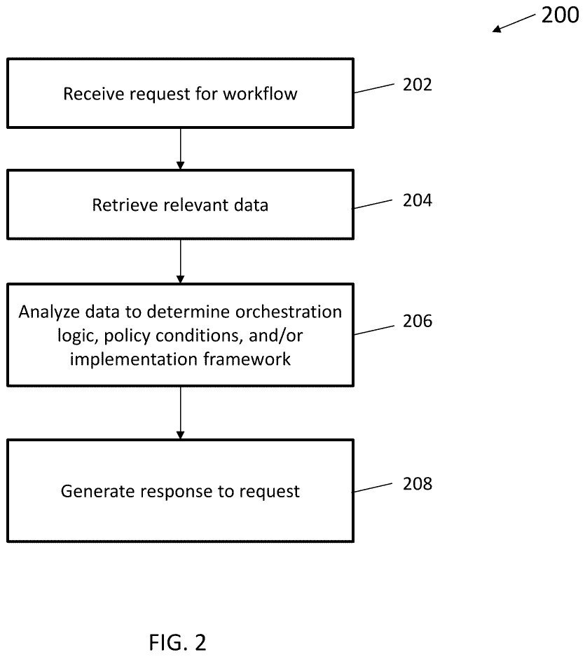

In some examples, the system 100 is configured to generate source code for workflows used the IAM system 110. FIG. 2 is a flowchart of a method 200 for generating workflow source code in accordance with aspects described herein. In some examples, the system 100 is configured to perform the method 200.

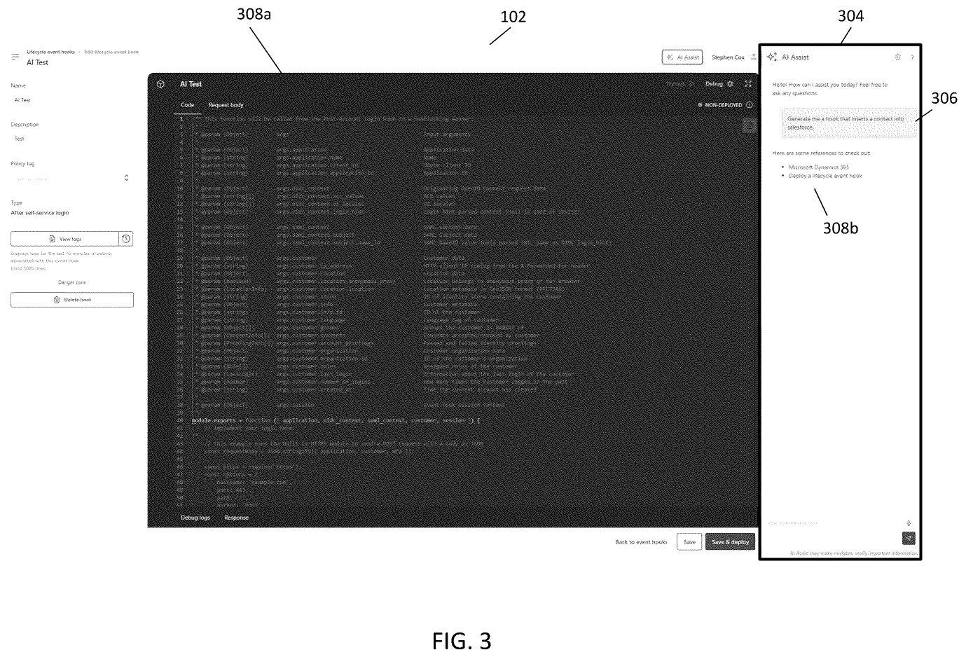

At step 202, the system 100 receives a request from a user (e.g., an administrator of the IAM system 110). In some examples, the user provides the request via the dashboard 102. For example, FIG. 3 illustrates an example dashboard 102 that includes an interface sidebar 304. The sidebar 304 includes a natural language processing (NLP) interface that allows the user to communicate with the AI model 112. In some examples, the sidebar 304 provides an intuitive UI where non-technical users or administrators can describe identity orchestration needs associated with the workflow. The user may enter a request 306 via the sidebar 304 (e.g., “Generate me a hook that inserts a contact into salesforce” or “Require multi-factor authentication for employees logging in from outside the corporate network.”). In some examples, the request 306 includes workflow details, such as conditions, triggers, and actions, in plain language. In some examples, the request 306 includes a programming language for the requested workflow. If no programming language is included, the system 100 may use a default programming language (e.g., JavaScript).

At step 204, the system 100 retrieves data that is relevant to the request 306. In some examples, the workflow engine 104 is configured to retrieve data from the plurality of databases 108 based on the request 306. In some examples, the databases 108 include documentation for the IAM system 110, instructions or checklists for generating types of workflows, code repositories, API documentation, and workflow-specific databases. The workflow engine 104 may reformat the request 306 into a standardized form, or split the request 306 into sub-tasks, before retrieving data from the databases 108. In some examples, the workflow engine 104 is configured to retrieve data using retrieval-augmented generation (RAG) techniques. For example, the workflow engine 104 may include a retrieval model optimized for RAG (e.g., a Bidirectional Encoder Representations from Transformers (BERT) model or a sentence transformer model). In some examples, the workflow engine 104 uses a vector representation of the request 306 to identify and retrieve relevant information from the databases 108 by leveraging semantic embeddings and similarity search techniques. In such examples, the request 306 is transformed into a dense vector representation using the retrieval model. In some examples, the workflow engine 104 (or the retrieval model) is configured to transform the data in the databases 108 into corresponding vector representations.

These vector representations (or embeddings) capture the semantic meaning of the text, enabling the workflow engine 104 to assess relevance based on content rather than exact word matching. For example, when the request 306 is submitted, it is encoded into a vector that represents its semantic intent. This request vector is then compared to precomputed data vectors stored in at least one database of the plurality of databases 108. In some examples, the workflow engine 104 uses similarity measures such as cosine similarity or inner product. Data with the most similar vector embeddings are retrieved as relevant (e.g., typically as the top-k results with the highest similarity scores). By employing vector-based representations, the workflow engine 104 can retrieve semantically relevant information even when the request 306 and the stored data use different natural language wording.

In some examples, the retrieved data is used to augment the AI model's context, ensuring that the generated code aligns with the latest standards, correct specifications, and best practices. For example, if a user asks the AI model 112 to write code that integrates with a specific API, the retrieval phase may fetch the corresponding API documentation (e.g., from the databases 108) to ensure that the generated code uses the correct methods and parameters. As such, this approach ensures the AI model 112 receives up-to-date information, which is important when dealing with rapidly evolving programming tools and frameworks. It also enables customization, allowing the AI model 112 to generate code tailored to specific projects or domains by accessing private repositories or specialized frameworks. Additionally, retrieving data from the plurality of databases 108 reduces (or eliminates) the risk of errors or hallucinations, as responses from the AI model 112 are grounded in verified, retrieved data.

At step 206, the AI model 112 analyzes the retrieved data to determine orchestration logic, policy considerations, and/or an implementation framework for the workflow associated with the request 306. Orchestration logic defines how the workflow should be structured and executed. The AI model 112 may derive orchestration logic from documentation detailing supported workflows, extensibility points supported by the workflow engine 104, and the inputs and outputs associated with discrete orchestration hooks. Policy considerations establish the boundaries within which the workflow operates. The AI model 112 may determine policy considerations based on documentation describing how policies function within the framework and/or by making an API call to retrieve the active policy. These policy considerations provide guidelines on how access control policies can be modified by code in the orchestration engine and how authorization data can be added and emitted. The implementation framework provides best practices for developing within the orchestration engine, including coding standards, reusable components, error handling strategies, and logging conventions. The implementation framework constrains how the AI model 112 generates code to ensure adherence to accepted practices. For example, if the workflow associated with the request 306 is a hook that calls an external system to step up an authentication, the AI model 112 uses the orchestration logic to determine where in the workflow the step up can occur and how to return an appropriate output. The AI model 112 uses the policy considerations to determine whether step up is permitted. The AI model 112 uses the implementation framework to generate code that conforms to accepted coding standards for the specified programming language.

In some examples, the AI model 112 determines the orchestration logic by analyzing documentation retrieved from the databases 108 that describes the architectural structure of the workflow engine 104, including supported workflow types, available extensibility points, and the sequence of execution stages within the IAM system 110. The AI model 112 parses the retrieved documentation to identify discrete orchestration hooks, which are predefined insertion points within the workflow execution pipeline where custom code can be injected. For each orchestration hook, the AI model 112 extracts metadata specifying the expected inputs, such as user attributes, authentication context, and session state, as well as the required outputs, such as authorization decisions, attribute transformations, and event triggers. The AI model 112 constructs a directed acyclic graph (DAG) representing the dependencies between orchestration hooks, wherein nodes correspond to individual hooks and edges represent data flow or control flow dependencies. The AI model 112 traverses the DAG to determine an optimal execution sequence that satisfies all dependency constraints while minimizing latency and computational overhead. By determining the orchestration logic prior to code generation, the AI model 112 ensures that the generated source code invokes the correct hooks in the proper sequence, thereby reducing runtime errors caused by incorrect hook ordering or missing dependencies.

In some examples, the AI model 112 determines the policy considerations by retrieving and analyzing policy documentation and active policy configurations from the databases 108 and the IAM system 110. The AI model 112 parses policy documentation to identify the types of access control policies supported by the IAM system 110, including role-based access control (RBAC) policies, attribute-based access control (ABAC) policies, and conditional access policies. For each policy type, the AI model 112 extracts policy schema definitions that specify the structure of policy rules, including permitted conditions, actions, and resource scopes. In some examples, the AI engine 106 invokes an API call to the IAM system 110 to retrieve the currently active policy configuration, including policy identifiers, rule definitions, and enforcement modes. The AI model 112 analyzes the active policy configuration to identify constraints that the generated source code must satisfy, such as required authentication levels, permitted user attributes, and prohibited actions. The AI model 112 generates a policy constraint matrix that maps each segment of the request 306 to applicable policy rules, enabling the AI model 112 to verify that the generated source code does not violate any active policy constraints. By determining policy considerations prior to code generation, the AI model 112 ensures that the generated source code operates within the boundaries established by organizational security policies, thereby reducing the risk of generating code that would be rejected by policy enforcement mechanisms or that would create security vulnerabilities.

In some examples, the AI model 112 determines the implementation framework by analyzing coding standards documentation, reusable code component libraries, error handling specifications, and logging conventions retrieved from the databases 108. The AI model 112 parses coding standards documentation to extract syntactic and stylistic rules for the specified programming language, including naming conventions for variables, functions, and classes, indentation and formatting requirements, and documentation comment formats. The AI model 112 indexes reusable code components retrieved from the databases 108, including utility functions, helper classes, and pre-built modules that implement common IAM operations such as token validation, attribute mapping, and event logging. For each reusable component, the AI model 112 extracts interface specifications including function signatures, parameter types, return types, and usage examples. The AI model 112 analyzes error handling specifications to identify required exception handling patterns, including the types of exceptions that must be caught, the error codes that must be returned, and the logging statements that must be generated when errors occur. The AI model 112 parses logging conventions to determine the required log levels, log message formats, and contextual information that must be included in log entries. The AI model 112 constructs an implementation constraint set that encapsulates all extracted coding standards, available reusable components, error handling patterns, and logging requirements. By determining the implementation framework prior to code generation, the AI model 112 ensures that the generated source code adheres to organizational coding standards and leverages existing reusable components, thereby improving code maintainability and reducing integration effort.

In some examples, the retrieved data is combined with the request 306 by the AI engine 106 and passed as input to the AI model 112, which synthesizes a source code response to the request 306. In some examples, the AI engine 106 is configured to feed the request 306 and the retrieved data to the AI model 112 using one or more prompts that instruct the AI model 112 to generate source code for a workflow based on the request 306. As described above, the AI model 112 may be a model included in the AI engine 106 or an external model that the AI engine 106 communicate with via an API.

In some examples, the AI model 112 uses the determined orchestration logic, policy considerations, and implementation framework to constrain the code generation process, thereby improving the accuracy and reliability of the generated source code. The AI model 112 implements a constrained decoding mechanism that modifies the token probability distribution during inference to favor tokens that are consistent with the determined constraints. During each decoding step, the AI model 112 computes a base probability distribution over candidate tokens using the learned model parameters. The AI model 112 then applies a constraint satisfaction layer that adjusts the probability distribution based on the orchestration logic, policy considerations, and implementation framework. Specifically, the constraint satisfaction layer increases the probability of tokens that correspond to correct orchestration hook invocations as specified by the orchestration logic, decreases the probability of tokens that would generate code violating active policy constraints as specified by the policy considerations, and increases the probability of tokens that conform to coding standards and reference available reusable components as specified by the implementation framework. The constrained decoding mechanism ensures that the AI model 112 generates source code that is structurally correct, policy-compliant, and stylistically consistent, thereby reducing the frequency of syntax errors, policy violations, and integration failures in the generated code.

In some examples, the AI model 112 is trained iteratively (e.g., via the AI engine 106) to improve the accuracy of the model's analysis. For example, the AI model 112 may be trained using extensive datasets of code, documentation, and programming discussions. In some examples, the training process begins with data collection from publicly available repositories (e.g., GitHub) and/or private repositories (e.g., of existing IAM workflow code), supplemented by documentation, tutorials, and examples that are specifically tailored to IAM workflows. In some examples, such datasets encompass multiple programming languages, including Python, JavaScript, C++, and Java. The training data may be preprocessed by tokenizing code into smaller, meaningful units such as keywords or operators, normalizing formatting inconsistencies, and preserving contextual structures like functions and classes to help the AI model 112 understand code dependencies and interactions. During a pretraining process, the AI model 112 learns syntax and patterns by predicting the next token in a sequence, and fine-tuning on specific tasks or datasets to optimize performance for targeted use cases for IAM workflows. Reinforcement learning techniques, such as Reinforcement Learning from Human Feedback (RLHF), may be employed, allowing human programmers to guide improvements by evaluating the model's outputs. In some examples, the trained AI model 112 is evaluated using automated testing with predefined test cases, metrics such as execution success rates and semantic similarity, and human reviews for style, readability, and best practices adherence. After deployment, the AI model 112 may continue to improve through interactive feedback from users and periodic retraining to incorporate evolving programming standards and user needs.

In some examples, the AI model 112 generates code for the request 306 by predicting the most likely sequence of tokens, such as characters, words, or code snippets, based on patterns learned during training. This process ensures that the generated code adheres to the syntax rules of the specified programming language and satisfies the constraints provided in the request 306, as well as the determined orchestration logic, policy considerations, and/or implementation framework for the workflow.

At step 208, the workflow engine 104 generates a response to the request 308. An example response 308 is shown in FIG. 3. In some examples, the response 308 includes a source code portion 308a and a supplemental portion 308b. The source code portion 308a includes the source code for the requested workflow. In some examples, the source code portion 308a may be deployed in the dashboard 102 (e.g., via a button) to implement the requested workflow in the IAM system 110. In some examples, the user may test and debug the source code portion 308a in the dashboard 102. In some examples, the source code portion 308a is the direct output from the AI model 112 provided via the AI engine 106. In some examples, the workflow engine 104 is configured to format the source code portion 308a from the AI model 112 to improve readability and/or to match stylistic aspects of IAM system 110 (e.g., by adding headers, comments, etc.). In some examples, the workflow engine 104 is configured to verify the source code portion 308a adheres to syntax requirements as well as security best practices and organizational standards. In some examples, the supplemental portion 308b includes links that direct the dashboard user to references associated with the source code or the corresponding workflow. In some examples, the supplemental portion 308b includes (or links to) instructions for implementing the source code portion 308a.

In some examples, the AI engine 106 implements a verification module that validates the generated source code against the determined orchestration logic, policy considerations, and implementation framework prior to returning the response to the user. The verification module parses the generated source code to extract a structural representation including function definitions, control flow statements, and API invocations. The verification module compares the extracted structural representation against the orchestration logic to verify that all required orchestration hooks are invoked in the correct sequence and that all required inputs and outputs are properly handled. The verification module analyzes the generated source code to identify operations that interact with access control mechanisms and compares these operations against the policy considerations to verify that no policy constraints are violated. The verification module scans the generated source code to verify compliance with the implementation framework, including adherence to naming conventions, proper use of reusable components, correct implementation of error handling patterns, and inclusion of required logging statements. If the verification module detects any discrepancies between the generated source code and the determined constraints, the AI engine 106 automatically invokes the AI model 112 to regenerate the non-compliant code segments with additional guidance derived from the verification results. This verification and regeneration loop continues until the generated source code satisfies all constraints or a maximum iteration threshold is reached, thereby ensuring that the final source code output is accurate, policy-compliant, and production-ready.

In some examples, the use of orchestration logic, policy considerations, and implementation framework to guide code generation provides measurable improvements to the accuracy of the AI model 112. By constraining the output space of the AI model 112 to code that satisfies the determined constraints, the system 100 reduces the incidence of hallucinated code, which refers to syntactically valid but semantically incorrect code that does not perform the intended function. The orchestration logic ensures that the AI model 112 generates code that correctly interfaces with the workflow engine 104, reducing integration errors that would otherwise require manual debugging. The policy considerations ensure that the AI model 112 generates code that complies with organizational security policies, reducing the risk of generating code that would be rejected during security review or that would introduce vulnerabilities into the IAM system 110. The implementation framework ensures that the AI model 112 generates code that conforms to established coding standards and leverages existing reusable components, reducing code duplication and improving maintainability. In some examples, the system 100 tracks accuracy metrics including the percentage of generated code that passes automated validation, the number of regeneration iterations required to produce compliant code, and the frequency of manual corrections applied by users. These accuracy metrics are used to continuously improve the AI model 112 through fine-tuning on successful code generation examples and adjustment of constraint satisfaction parameters.

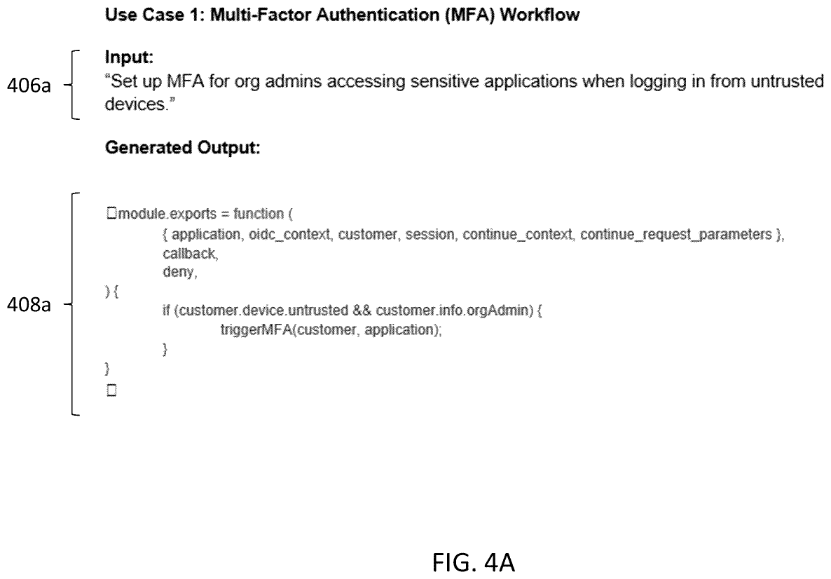

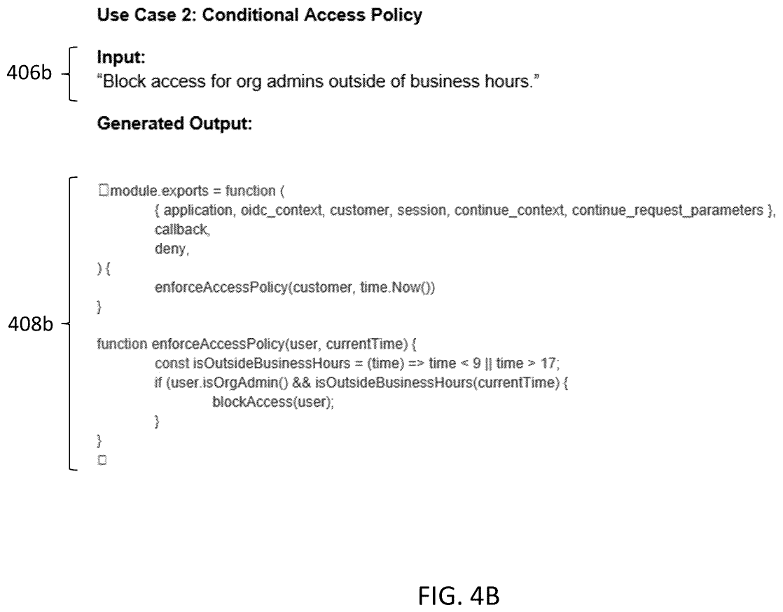

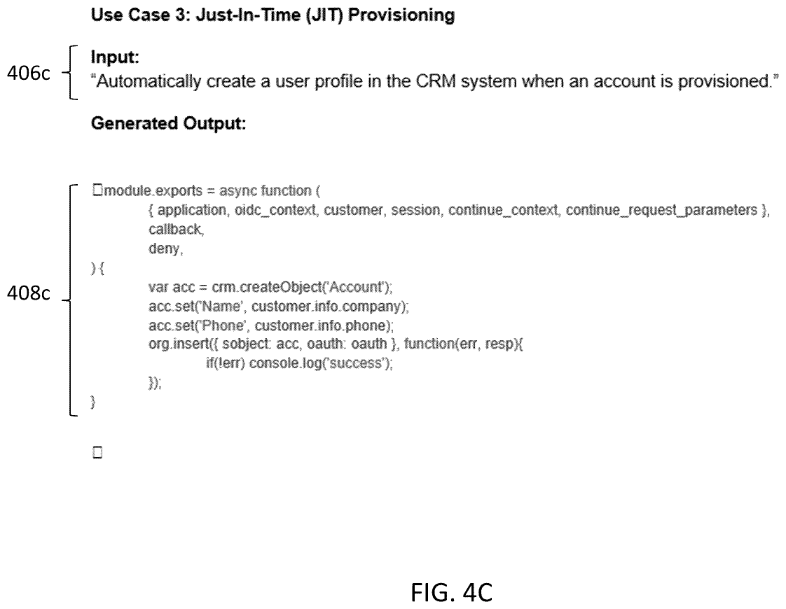

FIGS. 4A-4C illustrate additional examples of source code workflows generated by the system 100. FIG. 4A illustrates an example MFA workflow. As shown, a request 406a (“Set up MFA for org admins accessing sensitive applications when logging in from untrusted devices.”) is used to generate a source code response 408a. Likewise, FIG. 4B illustrates an example conditional access policy workflow where a request 406b (“Block access for org admins outside of business hours.”) is used to generate a source code response 408b. FIG. 4C illustrates an example JIT provisioning workflow where a request 406c (“Automatically create a user profile in the CRM system when an account is provisioned.”) is used to generate a source code response 408c.

While the above examples describe the request 308 as a request to generate source code for a new identity workflow, it should be appreciated that the request 308 may include a request to modify an existing identity workflow of the IAM system 110. In such examples, the data retrieved from the plurality of databases 108 in step 204 may include a copy of the source code for the existing identity workflow to be modified. For more complex tasks, the AI model 112 may refine its source code output based on feedback, iterating to better match the requirements desired by the requester, and allowing developers to fine-tine generated workflows to meet nuanced requirements. In some examples, the system 100 generates customizable code templates for specific identity use cases. Such code templates may be reused by developers to handle edge cases or advanced configurations that are best suited for manual intervention.

### Some Embodiments

Some embodiments may include any of the following:

A1. A method for generating source code for workflows used in an Identity and Access Management (IAM) system, the method including receiving a request relating to a workflow in association with an IAM system; retrieving data that is contextually relevant to the request from at least one database; analyzing, via a generative artificial intelligence (AI) model, the retrieved data to determine orchestration logic, policy considerations, and an implementation framework for the workflow; and generating, via the generative AI model, a response to the request that includes source code for deploying the workflow in the IAM system, the source code being generated to comply with the orchestration logic, policy considerations, and implementation framework.

A2. The method of clause A1 can include any of the following components or features, in any combination. Retrieving data includes comparing vector representations of the request and data stored in the at least one database using semantic similarity measures. The orchestration logic defines an execution sequence for the workflow based on dependencies between orchestration hooks of the IAM system. The orchestration hooks correspond to predefined insertion points for the generated source code. The policy considerations establish operational boundaries for the workflow based on access control policies of the IAM system. The implementation framework specifies at least one of coding standards, reusable code components, error handling strategies, or logging conventions. The request is received via a natural language processing (NLP) interface. The generative AI model implements a constrained decoding mechanism that modifies token probability distributions during inference based on the at least one of orchestration logic, policy considerations, or implementation framework. The workflow comprises at least one of a user provisioning workflow, an access request workflow, an authentication workflow, or an authorization workflow. The response further includes supplemental information comprising at least one of references associated with the source code or instructions for implementing the source code.

A3. A system for generating source code for workflows used in an Identity and Access Management (IAM) system, the system including at least one memory device with computer-executable instructions stored thereon; and at least one processor for executing the computer-executable instructions stored on the at least one memory device. Execution of the computer-executable instructions by the at least one processor causes the at least one processor to perform operations including: receive a request relating to a workflow in association with an IAM system; retrieving data that is contextually relevant to the request from at least one database; analyzing, via a generative artificial intelligence (AI) model, the retrieved data to determine orchestration logic, policy considerations, and an implementation framework for the workflow; and generating, via the generative AI model, a response to the request that includes source code for deploying the workflow in the IAM system, the source code being generated to comply with the orchestration logic, policy considerations, and implementation framework.

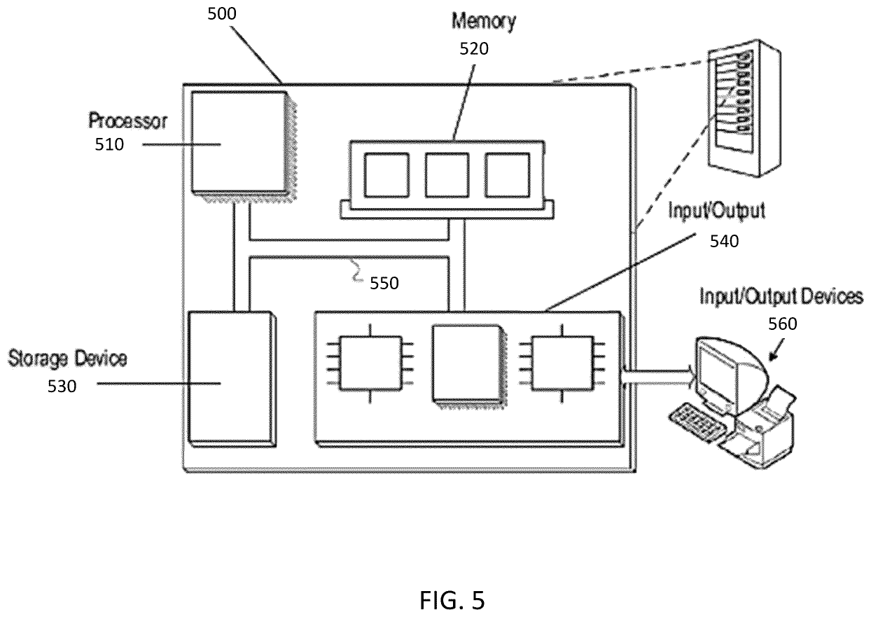

FIG. 5 shows an example of a generic computing device 500, which may be used with some of the techniques described in this disclosure. Computing device 500 includes a processor 502, memory 504, an input/output device such as a display 506, a communication interface 508, and a transceiver 510, among other components. The device 500 may also be provided with a storage device, such as a micro-drive or other device, to provide additional storage. Each of the components 500, 502, 504, 506, 508, and 510, are interconnected using various buses, and several of the components may be mounted on a common motherboard or in other manners as appropriate.

The processor 502 can execute instructions within the computing device 500, including instructions stored in the memory 504. The processor 502 may be implemented as a chipset of chips that include separate and multiple analog and digital processors. The processor 502 may provide, for example, for coordination of the other components of the device 500, such as control of user interfaces, applications run by device 500, and wireless communication by device 500.

Processor 502 may communicate with a user through control interface 512 and display interface 514 coupled to a display 506. The display 506 may be, for example, a TFT LCD (Thin-Film-Transistor Liquid Crystal Display) or an OLED (Organic Light Emitting Diode) display, or other appropriate display technology. The display interface 514 may comprise appropriate circuitry for driving the display 506 to present graphical and other information to a user. The control interface 512 may receive commands from a user and convert them for submission to the processor 502. In addition, an external interface 516 may be provided in communication with processor 502, so as to enable near area communication of device 500 with other devices. External interface 516 may provide, for example, for wired communication in some implementations, or for wireless communication in other implementations, and multiple interfaces may also be used.

The memory 504 stores information within the computing device 500. The memory 504 can be implemented as one or more of a computer-readable medium or media, a volatile memory unit or units, or a non-volatile memory unit or units. Expansion memory 518 may also be provided and connected to device 500 through expansion interface 520, which may include, for example, a SIMM (Single In Line Memory Module) card interface. Such expansion memory 518 may provide extra storage space for device 500, or may also store applications or other information for device 500. Specifically, expansion memory 518 may include instructions to carry out or supplement the processes described above, and may include secure information also. Thus, for example, expansion memory 518 may be provided as a security module for device 500, and may be programmed with instructions that permit secure use of device 500. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 504, expansion memory 518, memory on processor 502, or a propagated signal that may be received, for example, over transceiver 510 or external interface 516.

Device 500 may communicate wirelessly through communication interface 508, which may include digital signal processing circuitry where necessary. Communication interface 508 may in some cases be a cellular modem. Communication interface 508 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 510. In addition, short-range communication may occur, such as using a Bluetooth, WiFi, or other such transceiver (not shown). In addition, GPS (Global Positioning System) receiver module 522 may provide additional navigation-and location-related wireless data to device 500, which may be used as appropriate by applications running on device 500.

Device 500 may also communicate audibly using audio codec 524, which may receive spoken information from a user and convert it to usable digital information. Audio codec 524 may likewise generate audible sound for a user, such as through a speaker, e.g., in a handset of device 500. Such sound may include sound from voice telephone calls, may include recorded sound (e.g., voice messages, music files, etc.) and may also include sound generated by applications operating on device 500. In some examples, the device 500 includes a microphone to collect audio (e.g., speech) from a user. Likewise, the device 500 may include an input to receive a connection from an external microphone.

The computing device 500 may be implemented in a number of different forms, as shown in FIG. 5. For example, it may be implemented as a computer (e.g., laptop) 526. It may also be implemented as part of a smartphone 528, smart watch, tablet, personal digital assistant, or other similar mobile device.

Some implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for generating source code for workflows used in an Identity and Access Management (IAM) system, the method comprising:
receiving a request relating to a workflow in association with an IAM system;
retrieving data that is contextually relevant to the request from at least one database;
analyzing, via a generative artificial intelligence (AI) model, the retrieved data to determine orchestration logic, policy considerations, and an implementation framework for the workflow; and
generating, via the generative AI model, a response to the request that includes source code for deploying the workflow in the IAM system, the source code being generated to comply with the orchestration logic, policy considerations, and implementation framework.

2. The method of claim 1, wherein retrieving data comprises comparing vector representations of the request and data stored in the at least one database using semantic similarity measures.

3. The method of claim 1, wherein the orchestration logic defines an execution sequence for the workflow based on dependencies between orchestration hooks of the IAM system.

4. The method of claim 1, wherein the orchestration hooks correspond to predefined insertion points for the generated source code.

5. The method of claim 1, wherein the policy considerations establish operational boundaries for the workflow based on access control policies of the IAM system.

6. The method of claim 1, wherein the implementation framework specifies at least one of coding standards, reusable code components, error handling strategies, or logging conventions.

7. The method of claim 1, wherein the request is received via a natural language processing (NLP) interface.

8. The method of claim 1, wherein the generative AI model implements a constrained decoding mechanism that modifies token probability distributions during inference based on the at least one of orchestration logic, policy considerations, or implementation framework.

9. The method of claim 1, wherein the workflow comprises at least one of a user provisioning workflow, an access request workflow, an authentication workflow, or an authorization workflow.

10. The method of claim 1, wherein the response further includes supplemental information comprising at least one of references associated with the source code or instructions for implementing the source code.

11. A system for generating source code for workflows used in an Identity and Access Management (IAM) system, the system comprising:
at least one memory device with computer-executable instructions stored thereon; and
at least one processor for executing the computer-executable instructions stored on the at least one memory device, wherein execution of the computer-executable instructions by the at least one processor causes the at least one processor to perform operations comprising:
receive a request relating to a workflow in association with an IAM system;
retrieving data that is contextually relevant to the request from at least one database;
analyzing, via a generative artificial intelligence (AI) model, the retrieved data to determine orchestration logic, policy considerations, and an implementation framework for the workflow; and
generating, via the generative AI model, a response to the request that includes source code for deploying the workflow in the IAM system, the source code being generated to comply with the orchestration logic, policy considerations, and implementation framework.

12. The system of claim 11, wherein retrieving data comprises comparing vector representations of the request and data stored in the at least one database using semantic similarity measures.

13. The system of claim 11, wherein the orchestration logic defines an execution sequence for the workflow based on dependencies between orchestration hooks of the IAM system.

14. The system of claim 11, wherein the orchestration hooks correspond to predefined insertion points for the generated source code.

15. The system of claim 11, wherein the policy considerations establish operational boundaries for the workflow based on access control policies of the IAM system.

16. The system of claim 11, wherein the implementation framework specifies at least one of coding standards, reusable code components, error handling strategies, or logging conventions.

17. The system of claim 11, wherein the request is received via a natural language processing (NLP) interface.

18. The system of claim 11, wherein the generative AI model implements a constrained decoding mechanism that modifies token probability distributions during inference based on the at least one of orchestration logic, policy considerations, or implementation framework.

19. The system of claim 11, wherein the workflow comprises at least one of a user provisioning workflow, an access request workflow, an authentication workflow, or an authorization workflow.

20. The system of claim 11, wherein the response further includes supplemental information comprising at least one of references associated with the source code or instructions for implementing the source code.
